(19) United States
(12) Patent Application Publication
(10) Pub. No.: US 2025/0027365 A1
(43) Pub. Date: Jan. 23, 2025

(54) ACCESS OPENINGS IN SCREENS

(71) Applicant: Paul Kerr, Wellington Point (AU)

(72) Inventor: Paul Kerr, Wellington Point (AU)

(21) Appl. No.: 18/684,227

(22) PCT Filed: Aug. 23, 2022
(86) PCT No.: PCT/AU2022/050962

§ 371 Date: Feb. 16, 2024

(30) Foreign Application Priority Data
Aug. 24, 2021 (AU) 2021902668
Mar. 31, 2022 (AU) 2022900839

(51) Int. Cl. E06B 9/52; E06B 7/32

(52) U.S. Cl. CPC E06B 9/52; E06B 7/32; E06B 2009/528

(57) ABSTRACT

A window frame 10 and shown in phantom beyond the window frame are window wings 11 and 12. Fitted to the window frame is a fly screen frame 13 having a fly screen 14 filling the frame 13. A portal 15 is located below the midline of the screen and has a fixed frame section 16 fitted to the screen 14 and a moveable frame section 17 shown in a fully open position. Controls, in this case a handle and latch 18 can be seen through the fixed frame 16.

### TECHNICAL FIELD

THIS INVENTION relates to access openings in screens or the like barriers and in particular but not limited to access openings through insect screens.

### BACKGROUND

Inclusion herein of any prior art or background discussion should not be taken as admission that any matter discussed, including problems identified and solved by the Applicant, were known to anyone apart from the Applicant, were public knowledge or common general knowledge anywhere.

Screens or barriers of various kinds are known where it may be required to gain access to a region on the other side of the screen. This is particularly a case where the screens are fixed screens or there may be some difficulty in removing the screen in order to gain access or it may simply be inconvenient to do so on a routine basis. One example is an outward swinging window as the flyscreen must be fitted inside the window.

In order to avoid having to remove the whole screen it is usual to provide an opening through the screen. In some cases a control arm or other arrangement may protrude back through the opening so that a user may operate the window remotely through the screen. In other cases an opening may be so dimensioned and arranged and positioned for a user's hand or hand and forearm to pass through for the purpose of manual operations beyond the screen.

Windows per se, particularly hinged windows, have been around for many years as have fly screens. As early as 1949 GB662,410 based on an earlier Australian Application described a casement window with a flyscreen where an operating lever passes through an opening below the screen.

US 2003/0019173 describes sliding fly screens or roller fly screens so whole or part of the screen may be displaced to gain access.

KR20110084600A describes a screen for a casement window. A small hinged door is fitted with screen material and is located within the main screen.

Clearly, the present invention arises in a “crowded” or “mature” art. Applicant commissioned a PCT Article 15/5 search by the Australian Patent Office. That search revealed five “category A” documents as the nearest related art being: D1-KR20110084600A describes three separate embodiments, in FIG. 1 an inverted U-shaped frame abuts the bottom of the window frame, so it is not completely surrounded by screen, it has a door hinged at on pins at the top so the door swings up, in FIG. 4 the same frame has a door hinged on pins at the bottom so the doors swings down, in these cases the door fruits inside the frame, in FIG. 6 a rectangular frame with a radiused top has a same shaped door and these a pinned together with a wire loop at the apex so it is loose fitting door that swings up, magnets ar employed to hold the door closed, in each case the user must hold the door open with one hand while operating the casement window with the other hand; D2-CN202401946U describes a rectangular frame with two spaced hinges to a hinged door which appears to be hinged along the vertical edge of the frame. The door appears to have a hand release clip closure along the edge opposite the hinges; D3-KR20180025549A describe various screens that accommodate the movement of the actual casement window with the screen on the outside, there are embodiments that employ whole screens fitted using hook and loop fabric fasteners, one of these in FIG. 7 has a small portal for access to the handle of the window but there is no detail, it appears to be a small swinging hinged door; D4-CN210530690U describes a C-shaped frame with track carrying a horizontal sliding door; D5-JPS5791996U describes a frame with a flexible door held by hook and loop fabric fasteners which may be peeled back.

The Applicant's invention should be viewed through the lens of a crowded and mature art in order to demonstrate that in all the circumstances the notional skilled person would be presented with many similar solutions to the present invention. Since the present invention arises in a crowded art it would be prima facie wrong to suggest that there was, or is, apart from the very general problem of operating a window on the other side of a screen, any particular problem or motivation extant at the filing date of the present application that would give rise to the non-inventive notional person coming up with the present invention either in idea, concept or practical form. Thus the recognition and the present conception may be considered as whole or part of the Applicant's inventive step.

With this and the other background factors, including as set out above in mind, it should be clearly appreciated to the reader, that it is elementary that exercise of the inventive faculty in all the circumstances, in such a crowded art, is likely to be present in small variations. In such a crowded art we should not expect a major step forward. This is a background observation in hindsight only and is not to say that any of Applicant's new features whether individually or in combination are in any way slight or small. All that is required is a “scintilla” of invention. Simplicity, particularly in an old and crowded art, may argue for rather than against patentability.

### OUTLINE

In one aspect there is provided, in a window or door having a main screen, a frame defining a small opening through the main screen and a door conformed to slidably close the opening. The opening may be a portal to access window controls through a screen. Therefore in one preferred form there is provided a window portal fittable in a screen overlaying a window for accessing window wing controls through the portal, the portal having a fixed frame adapted to be fitted in the screen forming a hole in the screen, the portal having the said fixed frame and a movable door coupled to the fixed frame, the moveable door being alignable with the fixed frame so that when it is moved to a closed position it closes the portal, characterised in that, the fixed frame and door being are in intimate contact such that the movable door may be rotated in its position across the fixed frame while being self holding in an open position for single handed operation. The inmate contact typically comprises sliding frictional contact adjacent a pivot between the door and the frame sufficient to hold the door at any position in its travel or the intimate contact may be at or adjacent to the end of travel as in a detent to self hold while open. The opening may be oval in form. It may be sized to allow passage of a user's hand and forearm. The door typically is a frame infilled with a screen. The door frame is typically the same or similar to match the fixed frame.

The first mentioned frame or in use the fixed frame, typically, is sized so that its opening in the portal provides a hand pass through passage. The door may be manually slidable across the first frame between open and closed positions. The door typically comprises a second frame with screen infill. The frames may be made in an injection moulding process and the same injection moulded part may be used for both frames.

Preferably, the open position is a self holding position so that a user may open the door and then it remains open while the user operates the window through the opening. The self holding action may be promoted by a tightenable connector between the frames.

Preferably, the door is conformed to resist manual movement. In this case the self holding action normally occurs over the full range of movement. There may be any form of resistance employed including friction between the parts. There may be resistance in discrete locations while the parts just touch lightly in others. In one form this resistance is provided by a gasket or gaskets. The gasket may be a resilient gasket between the frame and the door. It may be a resiliently compressible gasket, the gasket may be fitted in a contact region where the door remains in contact with the frame when in the open position. For example, it may be in a region where the frames are connected or joined. If there is a pivot connection it may be around the pivot connection. The gasket may have a slight bulge which contacts the adjacent frame. The gasket may be fitted in a groove running around the door or the first mentioned frame. For example a large O-ring may be used on either frame. In one form the gasket may be provided by a protruding margin of a flexible and compressible spline material fitted into a channel in the door. This spline may also serve to hold the screen infill in the door.

Typically each frame is a closed loop. The frames may be matching in their contact regions and be generally oval in form. The frames may have co-operating projections, grooves or detents or other parts which may come into a self holding registry at the open position. There may be a passive or active bias involved. A passive bias would be the gasket or fixed detent projection and recess, whereas an active bias may involve a spring, being a separate spring fitted into one or other frame, or an integral projecting resilient tab or an integrally formed manually releasable catch.

Preferably, when the door is closed, the door hangs from the frame at a pivot point. The pivot point typically has a pivot pin passing between the door and the frame. While a hanging pivot is preferred the door may pivot at any point on the frame. In one form the pivot may be tightened from a free swinging and hanging position to a tightened position where the door adopts a self holding position against the frame.

Preferably, the door and frame are sealed when the door is closed. The seal may be provided by a beaded rim around the door. The beaded rim may be integrally formed with the door. In another form the beaded portion may be a separate projecting part fitted into the door. There may be more than one bead. Conveniently, the or each bead may be provided by a projecting raised section of the gasket. Where a projecting bulge of a spline is employed this may also serve the sealing function.

Having regard to the above outline and variants as preferred there is provided a main screen having a frame defining a small opening through the screen and a door conformed to slidably close the opening. As further preference the opening provides a hand pass through passage closable by the door, the door being manually slidable across the first frame between open and closed positions, and further wherein the open position is a self holding position so that a user may open the door and then it remains open while the user operates the window through the opening. As further preference the door is conformed to resist manual movement. As further preference the self holding occurs over a full range of movement of the door. As further preference there is a bulged contact region between the door and the frame. As further preference a gasket is between the frame and door provided by a protruding margin of a flexible and compressible material fitted into a channel in the door. As further preference a spline serves to hold the screen infill in the door and bulges into frictional contact with the frame. As further preference the door hangs from the frame at a pivot point and slides in an arc between open and closed positions.

The above set out the additions of the frame and door to a main screen but it will be appreciated from the foregoing and made further clear from the description, that in the preferred form, all that is required to be sold in order to practice the invention is the first frame which may be used as both the first frame and the door. Thus there is further, a main screen access frame or door adapted to be fitted into a main screen according to any of the preceding description. In another form the fixed frame may be made from two parts when they are connected to each other may do so over the screen to automatically clamp the uncut screen between them. The screen is then cut inside the fixed frame using it as a guide to provide the hole and the movable frame is fitted to the fixed frame. The frame parts making up the fixed frame may be identical having sets of complementary connectors at opposite ends so that upon rotation of one half relative to the other before connection, the complementary connectors may be aligned and then they may be clipped together on opposite sides of a screen.

### BRIEF DESCRIPTION OF THE DRAWINGS

In order that the present improvements may be more readily understood and put into practical effect reference will now be made to the accompanying drawings which illustrate preferred embodiments of the invention and wherein:-

FIG. 1 is a drawing illustrating a framed opening according to one preferred form of the invention;

FIGS. 2A and 2B are opposite side views of a frame;

FIG. 3 is a side view of the frames overlapping each other before installation;

FIG. 4 shows the operation in terms of effective size, dimensions and positioning for a user's hand and forearm to pass through the screen in proximity to the opening relative to the controls being accessed;

FIG. 5 is a section through 5-5 of FIG. 1;

FIG. 6 is a section through 6-6 of FIG. 1;

FIG. 7 is a drawing of an alternative embodiment of a frame made from two parts that clamp the screen between the two parts negating the need for a spline;

FIGS. 8 and 9 a part sections through an in situ assembled frame of FIG. 7 and a door according to the previous embodiments; and

FIG. 10 is a top view of a door and frame of FIG. 7 in a closed position with the screens omitted.

### METHOD OF PERFORMANCE

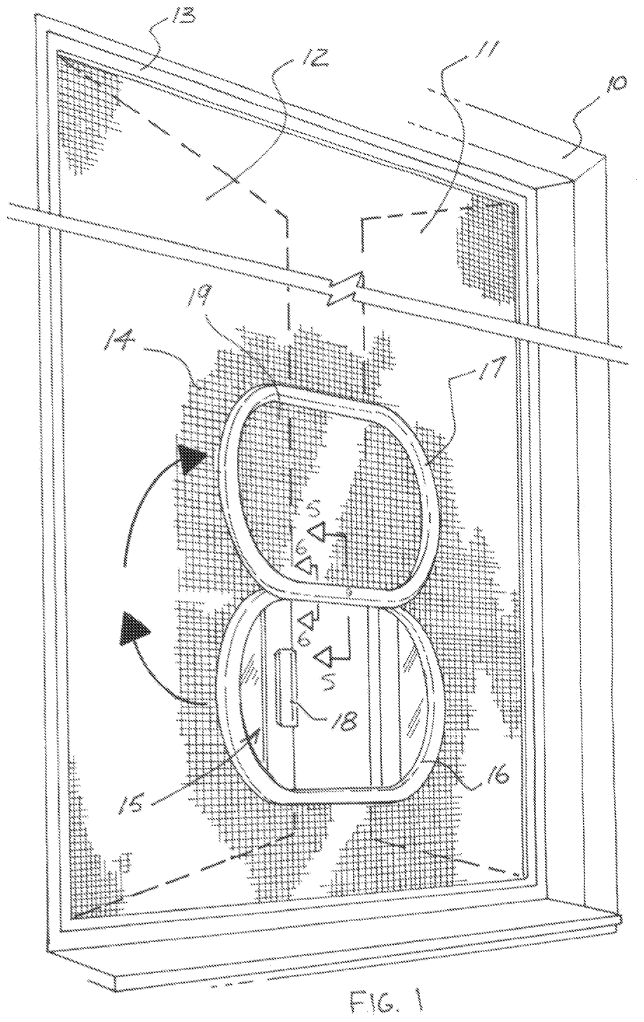

Referring to the drawings and initially to FIG. 1 there is illustrated a window frame 10 and shown in phantom beyond the window frame are window wings 11 and 12. Fitted to the window frame is a fly screen frame 13 having a fly screen 14 filling the frame 13. A portal 15 is located below the midline of the screen and has a fixed frame section 16 fitted to the screen 14 and a moveable frame section 17 shown in a fully open position. Controls, in this case a handle and latch 18 can be seen through the fixed frame 16.

The moveable frame 17 has its own screen 19 so that when it is moved to the closed position where it is matched to the fixed frame 16 and overlays it, there is an effective insect screen over the whole of the frame 13. Described below, the frames 16 and 17 have channels and with a suitable spline, a usual type spline fix is used to fix the insect screen material into the frames.

In the illustrated embodiment the frame 17 pivots about screw 26 and moves in a plane substantially parallel to the plane of the screen with the assembled frames 16 and 17 and their screens in the assembled form, being in intimate sliding contact. The pivot may be at any position. The frame may be inverted, it may be rotated in its position by 90 degrees or for that matter oriented in any position. It will normally have its long axis in a direction to suit the user's arm position. While self holding is preferred other options are available to hold the slidable frame in an open position including a latch, integrally formed recesses and projections which releasably engage in a press fit or detent type action. The frames may still be identically moulded but this is not essential as a mould having two different frames could be used.

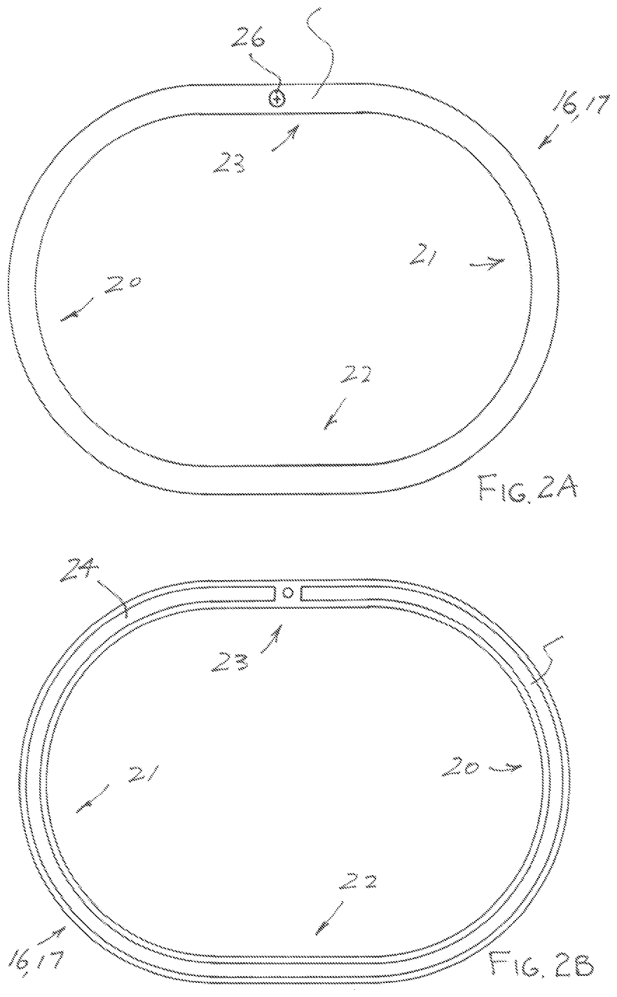

The frame sections 16 and 17 are illustrated in FIGS. 2A and 2B and to this extent the frames include bulged sections 20 and 21 on either side of straight sections 22 and 23. On the opposite side there is a spline channel 24 that carries a resilient fly screen spline of the usual form in the channel to hold the frames 16 in the main screen and the screen 19 in the frame 17.

In the example the frame 17 and its contact with the frame 16 also serves to provide a seal for the opening when it is closed as well as to create a self-holding configuration so that the frame section 17 is automatically retained in a self-holding position when moved to the open position as shown in FIG. 1.

In both cases when a spline is inserted into the channel 24 this spline is outwardly facing in both the frame 16 and the frame 17. The spline in frame 17 is sandwiched between the frames in compressing sliding engagement with sufficient pressure to maintain pressure contact so that the frame 17 stays wherever put. As an alternative the self holding need only be at the open position. The sections 22 could have knurled regions or ribbed regions that hold the frames in the position as shown in FIG. 1.

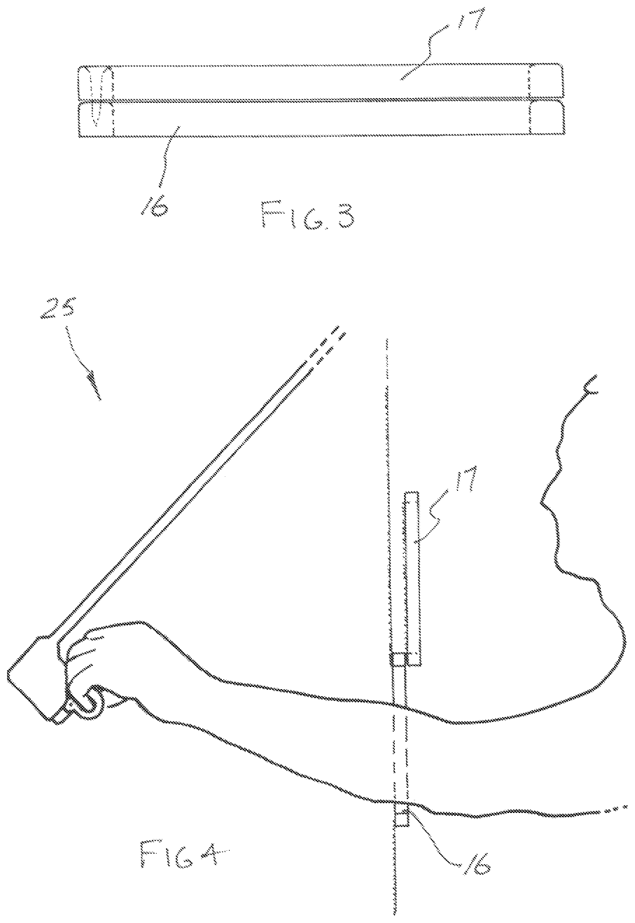

In the example the frames are identical and in so far as this is shown, the frames shown overlaying in FIG. 3, so a single mould may be used for both frames 16 and 17.

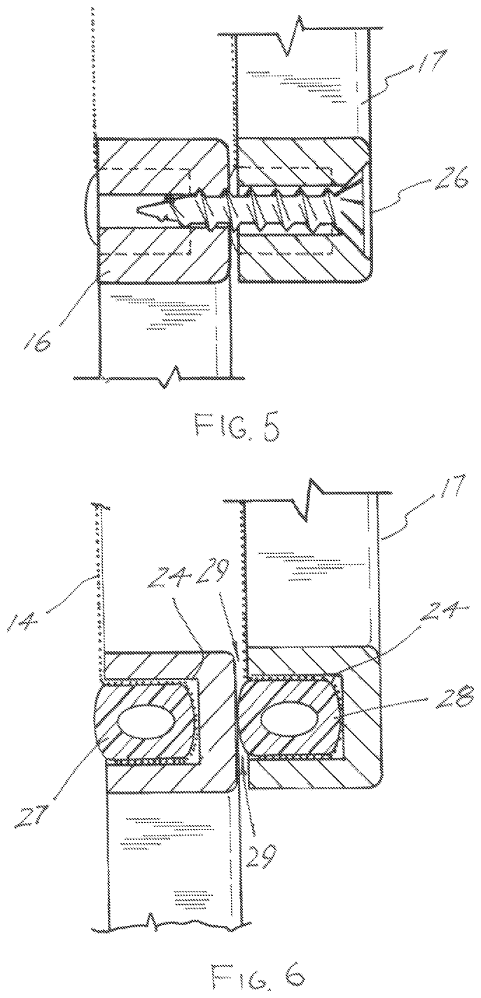

The frames may be used with any screen with the position customised by the installer. FIG. 5 shows another operation employing a window 25 which is hinged along the top end of the window as opposed to the type of window illustrated in FIG. 1. The same frame assemblies as depicted previously may be used and the position may be adjusted to suit the location of the latch or other controls employed.

The screw fitting at 26 retains the two frame sections 16 and 17 in operative position and creates the pivot point for rotation of the frame 17. Splines 27 and 28 are employed, it being noted that the spline 28 in the region 29 has been so dimensioned and arranged that it provides a frictional and compressive engagement with the face 30 of the frame section 16. The pressure afforded is self holding in any operative position by reason of that compressive and frictional hold. The screw hole is shown passing right through the frames so in this example the frames are the same being moulded in the same mould.

In use the frames are added to the main screen by cutting a hole and the spline fixing the first frame into the hole, the door frame may come prefilled with screen material so it is simply a matter of screwing the door in place.

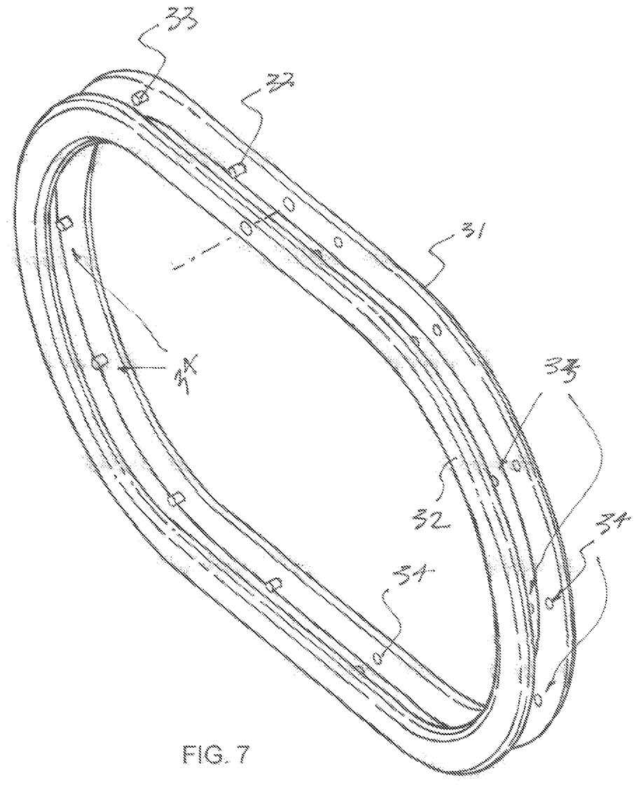

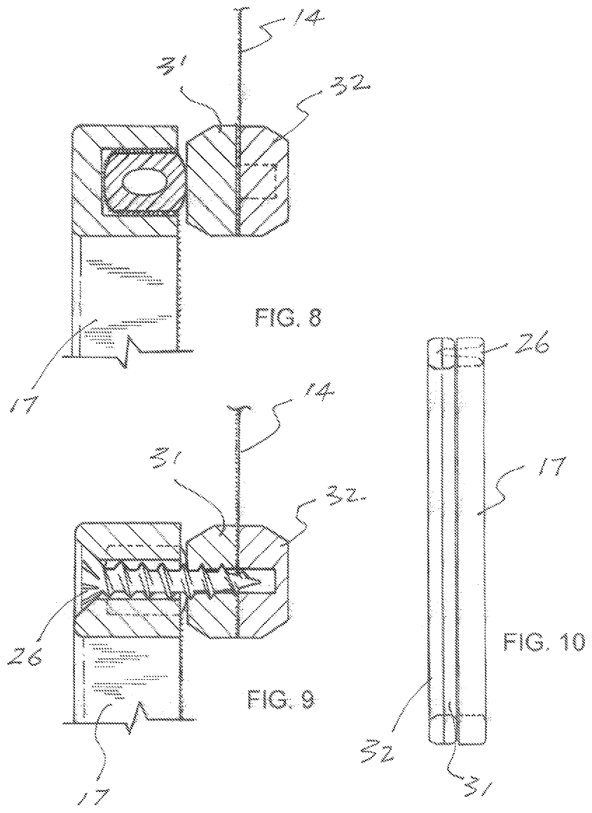

As an alternative to using a spline in the frame, the frame may be made from two parts 31 and 32 as shown in the exploded view in FIG. 7 which when connected as shown in FIG. 8 through 10 clamp the screen between them. The screen is then cut to provide the hole and the door is fitted in the same way as in the previous embodiment. The door retains the spline so the spline is still just proud of the door to provide the resistance and seal as before. In FIG. 7 the frame parts 31 and 32 are identical having one being rotated 180 degrees relative to the other so that the set of spaced pegs 33 align with the set of spaced holes 34 and the parts may be clipped together on opposite sides of a screen.

Whilst the above has been given by way of illustrative example many variations and modifications will be apparent to those skilled in the art without departing from the broad ambit and scope of the invention as set out in the appended claims.

What is claimed is:

1. A window portal fittable in a screen overlaying a window for accessing window wing controls through the portal, the portal having a fixed frame adapted to be fitted in the screen forming a hole in the screen, the portal having the said fixed frame and a movable door coupled to the fixed frame, the moveable door being alignable with the fixed frame so that when it is moved to a closed position it closes the portal, characterised in that, the fixed frame and door are in intimate contact such that the movable door may be rotated in its position across the fixed frame while being self holding in an open position for single handed operation.

2. A window portal according to claim 1 wherein the intimate contact comprises sliding frictional contact adjacent a pivot between the door and the frame sufficient to hold the door at any position in its travel or the intimate contact is at or adjacent to an end of travel for the door to self hold while open.

3. A window portal according to claim 1, the door being manually slidable across the first frame between open and closed positions.

4. A window portal according to claim 1, the self holding of the door is promoted by a tightenable connector between the frames.

5. A window portal according to claim 1, wherein the frame and/or door comprise clipped together parts.

6. A window portal according to claim 1, wherein the self holding of the door is promoted by a tightenable connector between the frames and the frame is comprised of clipped together parts.

7. A window portal according to claim 1, wherein, the door is conformed to resist manual movement between open and closed positions.

8. A window portal according to claim 1, wherein the door resists movement and that resistance is provided by a gasket or gaskets between the frame and the door.

9. A window portal according to claim 1, wherein the door resists movement and that resistance is provided by a gasket or gaskets between the frame and the door fitted in a contact region where the door remains in contact with the frame via the gasket when in the open position, the gasket having a slight bulge which contacts the adjacent frame.

10. A window portal according to claim 1, wherein the door resists movement and that resistance is provided by a gasket or gaskets between the frame and the door fitted in a contact region where the door remains in contact with the frame when in the open position, the gasket having a slight bulge which contacts the adjacent frame, the gasket being provided by a protruding margin of a flexible and compressible spline material fitted into a channel in the door and holding screen infill in the door.

11. A window portal according to claim 1, wherein each frame is a closed loop, the frames having co-operating projections, grooves or detents or other parts which come into a self holding registry at the open position.

12. A window portal according to claim 1, wherein when the door is closed, the door hangs from the fixed frame at a pivot point.

13. A window portal according to claim 1, wherein the door and frame are sealed when the door is closed by a seal bridging the fixed frame and door.

14. A window portal according to claim 1, wherein the door and frame are sealed when the door is closed by a seal bridging the fixed frame and door and the seal comprises a projecting bulge of a spline employed to hold screen infill in the door.

15. A window portal according to claim 1 wherein the fixed frame is made from two connectable parts such that when they are connected to each other over screen material they automatically clamp the screen material between them, such that when the screen material is then cut inside the fixed frame using it as a guide to thereby provide an opening though the screen material, and such that the door is subsequently fitted to the fixed frame.

16. A window portal according to claim 15, wherein the fixed frame parts making up the fixed frame have sets of complementary connectors at opposite ends of the parts so that upon rotation of one part relative to the other before connection, the complementary connectors may be aligned and then they may be clipped together on opposite sides of a screen sandwiched between the parts.

17. A window portal according to claim 1 wherein the fixed frame and door are generally oval or rectangular with radiused ends having a longitudinal axis adapted to be set horizontally in use.

18. A window portal according to claim 1 in widow frame having window wings, fitted to the window frame is a fly screen frame having a fly screen filling the frame and surrounding the portal, the portal located below a mid-line of the screen and having the fixed frame section fitted to the screen and the door, wing controls accessible through the fixed frame of the portal, the door having its own screen so that when it is moved to a closed position it is matched to the fixed frame and overlays it such that there is an effective insect screen over the whole of the fly screen frame, the door having a spline and being adapted to move in a plane substantially parallel to the plane of the screens with the frame and door being in said intimate contact such that the door is rotatable in its position to enable access to the controls through the fixed frame section, the fixed frame section and the door, when closed having a long axis in a direction to suit a user's arm position for ease of access to the controls.

19. A window portal according to claim 1 wherein the fixed frame of the portal comprises two generally oval frames, the frames being fittable together to sandwich flat screen material between them when operatively positioned, screen material being removable to form a hole through the fixed frame and thereby though surrounding screen material, the door being rotatably fixed to the fixed frame at an axis of rotation, the axis of rotation being substantially at right angles to the plane of the flat screen material.
